(19) United States
(12) Patent Application Publication
(10) Pub. No.: US 2007/0184337 A1
(43) Pub. Date: Aug. 9, 2007

(54) Battery operated device

(76) Inventors: Masatoshi Nagayama, Osaka (JP); Tsuyoshi Hatanaka, Wakayama (JP); Hideaki Fujita, Osaka (JP)

Correspondence Address: MCDERMOTT WILL & EMERY LLP, 600 13TH STREET, NW, WASHINGTON, DC, 20005-3096, US

(21) Appl. No.: 11/651,611

(22) Filed: Jan. 10, 2007

(30) Foreign Application Priority Data
Jan. 18, 2006 (JP) 2006-009366

(51) Int. Cl. H01M 2/12

(52) U.S. Cl. 429/53; 429/82; 429/86

(57) ABSTRACT

A battery operated device is equipped with one or more batteries each including a positive electrode, a negative electrode, a separator, and an electrolyte in a battery case. In this battery operated device, the battery has a gas vent that is opened due to an increase in pressure inside the battery case, and is configured to dispose the gas vent at a lower position thereof when installed in the battery operated device. Therefore, the battery function is ceased due to actuation of the gas vent.

The present disclosure relates to subject matter contained in priority Japanese Patent Application No. 2006-9366 filed on Jan. 18, 2006, the contents of which is herein expressly incorporated by reference in its entirety.

### BACKGROUND OF THE INVENTION

1. Field of the Invention

The present invention relates to battery operated devices with a safety-improved battery.

2. Description of the Related Art

Well-known battery operated devices that use a battery as their power source include a wide variety of devices such as personal computers, portable electronic devices, various types of home electrical products, motor assisted bicycles, motor-driven wheelchairs, motorbikes, automobiles, electric vehicles including hybrid cars in particular, robots, power source devices such as for power supply or backup use.

Recently, those rechargeable batteries that are used with these battery operated devices have been increasingly improved in capacity and output power with an increase in energy to be stored in the battery. In this respect, the battery operated devices are designed to employ a control circuit for providing charge and discharge control as well as temperature control to the battery, thereby ensuring safety. There is also known a battery operated device to which a gas vent is provided in anticipation of an accident such as a failure in the control system, so that the gas vent can prevent the battery itself from exploding (e.g., see Japanese Patent Laid-Open Publication No. 2003-132868). Suppose that charge control cannot be provided leading to a battery being overcharged. In this case, there is a possibility that a gas produced suddenly inside the battery due to decomposition of a liquid electrolyte will fill in the battery, thereby causing the battery case to explode. However, the gas vent works to open at the designed operating pressure, thereby preventing the battery case from exploding.

As shown in FIG. 6A, a battery equipped with such a gas vent or a battery 52 is known, which is provided with a gas vent 55 that has a portion of an upper wall 54 of a battery case 53 reduced in thickness in two stages (e.g., see Japanese Patent Laid-Open Publication No. 2003-297324). Note that the battery shown in FIG. 6A has outer positive and negative electrode terminals 56 and 57 each protruding from the upper wall 54 near the respective edges thereof. As shown in FIG. 6B, to provide a higher output voltage than the output voltage of each battery 52, a plurality of batteries 52 is disposed in parallel, and the neighboring outer positive and negative electrode terminals 56 and 57 are sequentially connected to each other via connection plates 58 to form a battery group 51. The battery group 51 is incorporated into a battery operated device.

On the other hand, as shown in FIG. 7, such a battery 61 is also known which has an electrode plate group 63 and an electrolyte accommodated in a battery case 62, a positive electrode terminal 65 and a negative electrode terminal 66 protruding from an upper wall portion 64, and a gas vent 67 with an exhaust outlet 68 protruded from the upper wall portion 64 of the battery case 62 and covered with a safety cap 69. In the battery 61, a tilted portion 70 that is inclined upwardly towards the exhaust outlet 68 is provided on the inner surface of the upper wall portion 64. This allows produced gases not to form larger bubbles but to be smoothly exhausted through the exhaust outlet 68, thereby preventing the electrolyte from being emitted outside together with larger bubbles (e.g., see Japanese Patent Laid-Open Publication No. 2005-19084).

However, the batteries shown in FIGS. 6A, 6B, and 7 have the gas vents 55 and 67 disposed on the upper walls 54 and 64 of the battery cases 53 and 62, respectively. Thus, even when the gas vents 55 and 67 are opened, there will be still present some electrolyte that is not yet gasified inside the batteries 52 and 61. As a result, the battery function may continue to perform causing overcharge to continue, which in the worst case, may lead to generation of heat or smoke. To avoid this situation, such a battery is also available which employs a separator having a shut-down function and designed to close fine bores for passing the electrolyte therethrough at an increased temperature. However, this battery cannot completely reduce charging current to zero. Thus, a long-duration overcharge may cause a further increase in temperature, thereby causing a risk of generating smoke or catching fire when the thermal runaway temperature of the positive electrode or negative electrode material is reached.

### SUMMARY OF THE INVENTION

The present invention is developed in light of the aforementioned problems. It is therefore an object of the present invention to provide a battery operated device which ensures the stoppage of the battery function upon actuation of the gas vent to thereby provide improved safety such as at the time of overcharge.

A battery operated device according to the present invention is equipped with one or more batteries each including a positive electrode, a negative electrode, a separator, and an electrolyte in a battery case. The battery has a gas vent that is opened due to an increase in pressure inside the battery case, and is configured to dispose the gas vent at a lower position thereof when installed in the battery operated device.

According to this arrangement, upon actuation of the gas vent due to an increase in pressure within the battery case resulting from generation of gas, the electrolyte retained due to gravity at the bottom inside the battery case is allowed to be positively emitted outside through the gas vent, thereby causing the electrolyte inside the battery case to be significantly reduced. This in turn ensures that the battery function (generation of voltage and continuation of charge transfer) is ceased to disable further flow of current, thereby terminating overcharge. Furthermore, as the thermal runaway of the positive electrode and the negative electrode is known to be an exothermic reaction that occurs in the simultaneous presence of the electrolyte, the emission of the electrolyte from inside the battery case would also provide improved safety against heat. In this manner, the safety against overcharge after the actuation of the gas vent and for resistance to heat is dramatically improved.

The gas vent is preferably actuated at a pressure of 50 kPa or higher and 250 kPa or lower. When designed to actuate at a pressure below 50 kPa, the gas vent may be opened even during storage of the battery at a high temperature. In contrast, when designed to actuate at a pressure greater than 250 kPa, the gas vent may cause a further increase in temperature during overcharge, so that the electrolyte may unpreferably exceed its boiling point and be emitted when the vent is opened.

Furthermore, the battery operated device can also incorporate a battery pack which has a plurality of batteries loaded and packaged therein.

Furthermore, a liquid absorptive material may be preferably disposed at least under the gas vent of the battery, so that when emitted, the electrolyte will be absorbed by the liquid absorptive material and thus prevented from splattering around. In particular, the liquid absorptive material may be more effectively formed of a material which is coagulated or gelatinized when having absorbed the electrolyte. More specifically, the material that absorbs the electrolyte to thereby gelatinize may preferably include at least one selected from the group consisting of agar, carrageenan, xanthan gum, gellan gum, guar gum, polyvinyl alcohol, polyacrylate-based thickener, water-soluble celluloses, and polyethylene oxide.

According to a battery operated device of the present invention, the electrolyte can be positively emitted out of the battery case when the gas vent is actuated. As a result, the battery function is ceased to thereby provide dramatically improved safety against overcharge or the like. Furthermore, since the battery function is ceased due to actuation of the gas vent, a conventional current cut-off function is not required any more which makes use of internal pressure to physically cut off current paths. This allows for cutting down on costs.

The above and other objects and features of the present invention will become apparent from the following description of preferred embodiments given in conjunction with the accompanying drawings.

### BRIEF DESCRIPTION OF THE DRAWINGS

FIGS. 1A and 1B are views illustrating the configuration of a group of batteries according to a first embodiment of a battery operated device of the present invention, FIG. 1A being a perspective view of the battery group when viewed diagonally from above, FIG. 1B being a perspective view of the battery group when viewed diagonally from below;

FIG. 2 is a longitudinal sectional side view illustrating the configuration of a main portion of a battery pack in a hybrid car according to a second embodiment of a battery operated device of the present invention;

FIG. 3 is a perspective view illustrating the group of batteries of the battery pack;

FIG. 4 is a schematic perspective view illustrating the entire structure of the hybrid car according to the second embodiment;

FIG. 5 is a cross-sectional view illustrating the configuration of a battery pack according to an example;

FIGS. 6A and 6B are perspective views illustrating the configuration of a conventional example of a battery and a group of batteries; and

FIG. 7 is a longitudinal sectional view illustrating the configuration of a main portion of another conventional example of a battery.

### DETAILED DESCRIPTION OF THE PREFERRED EMBODIMENTS

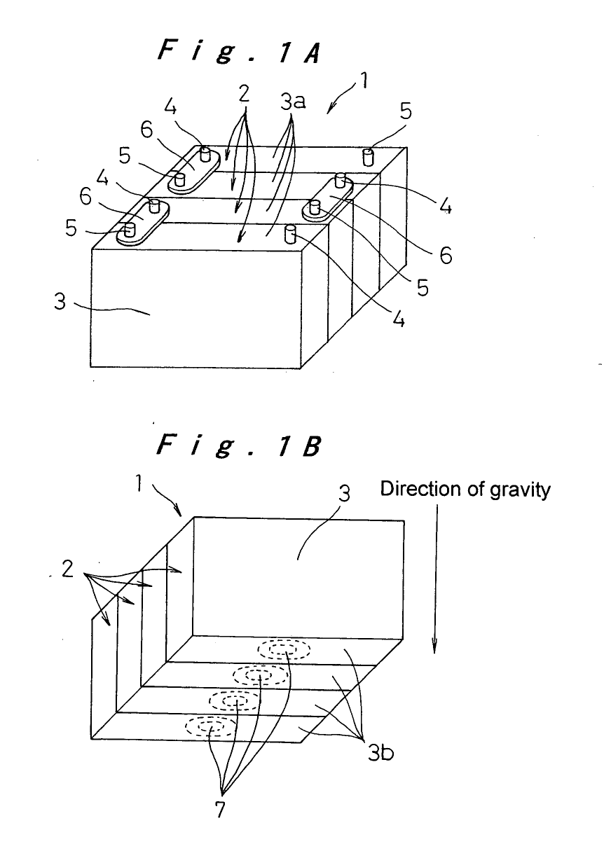

The present invention will now be described below in more detail with reference to FIGS. 1A to 4 in accordance with each embodiment of a battery operated device.

### First Embodiment

First, with reference to FIGS. 1A and 1B, a description will be given of a group of batteries which is loaded in a battery operated device according to a first embodiment of the present invention. In FIGS. 1A and 1B, a battery group 1 includes a plurality of batteries 2 such as lithium-ion batteries, and each battery 2 is designed to accommodate a positive electrode, a negative electrode, a separator, and an electrolyte in a battery case 3. The battery group 1 is loaded into any battery operated device (not shown) as illustrated in FIG. 1A with its orientation unchanged. Note that for a battery operated device (not shown) installed fixedly or a mobile or movable device with its vertical orientation remaining unchanged, the placement orientation of the battery group 1 remains unchanged as shown in FIG. 1A so that the present invention is effectively applicable. On the other hand, when a mobile or movable device being changeable in orientation or portable is not constant in orientation but takes a main fixed orientation, the present invention operates effectively in that orientation and is thus advantageously applicable.

The battery case 3 of the batteries 2 according to this embodiment is prismatic in shape, and has a positive electrode terminal 4 and a negative electrode terminal 5 connected to a positive electrode and a negative electrode, respectively, each terminal protruding from its upper wall 3a near the respective edges thereof. The battery case 3 may be formed of either resin or metal. The battery group 1 is arranged such that each battery 2 is disposed in parallel to another but alternately opposite in the sideward orientation, with the neighboring positive electrode terminal 4 and negative electrode terminal 5 sequentially connected to each other via a connection plate 6. Each battery 2 has a gas vent 7 provided at an appropriate portion on a lower wall 3b of the battery case 3.

The gas vent 7 can be prepared by forming a thin-film portion on part of the battery case 3, or alternatively, by securely sealing the exhaust outlet on the battery case 3 with a thin-film material by soldering, press-fit, or adhesive. The gas vent 7 is formed of metal foil, resin film or the like. The metal foil may be preferably formed of aluminum, nickel, stainless steel, iron, titanium, or the like, or of a clad material of them. The resin film may be formed of polypropylene, polyethylene, polyethylene terephthalate, nylon or the like, or of a composite material of these resins. On the other hand, the aforementioned resin film may also be preferably adhered to both the surfaces of the metal foil.

On the other hand, the thickness and area of the gas vent 7 may vary depending on the battery design, material selection, and service environment. However, what is essential is that the actuation pressure is 50 kPa or higher and 250 kPa or lower, and the area is sufficiently enough to smoothly emit the inner electrolyte therethrough after the vent is opened. Thus, the thickness and area are appropriately selected and designed according to the selected actuation pressure, electrolyte, and material of the positive and negative electrodes.

Suppose that overcharge occurs when each battery 2 of the battery group 1 is charged, and the electrolyte is decomposed into a gas, thereby causing an increase in pressure within the battery case 3. In this case, according to this embodiment, there is no possibility that the battery case 3 will explode, because the gas vent 7 will be actuated when a predetermined pressure is reached, thereby allowing the produced gas to be emitted outside. At the same time, since the gas vent 7 is disposed downstream of gravity, some electrolyte retained due to gravity at the bottom within the battery case 3 is positively emitted outside through the gas vent 7, leaving only a significantly reduced amount of electrolyte inside the battery case 3. This ensures that the battery function (generation of voltage and continuation of charge transfer) is ceased to disable further flow of current, thereby terminating overcharge itself at the same time the gas vent 7 is opened. Furthermore, the thermal runaway of the positive and negative electrodes within the battery 2, which is often experienced particularly with a lithium-ion battery, is known to be an exothermic reaction that occurs in the simultaneous presence of the electrolyte. Thus, the emission of the electrolyte from inside the battery case 3 provides improved safety against heat. In this manner, the safety against overcharge after the actuation of the gas vent 7 and for resistance to heat is dramatically improved.

Furthermore, the actuation pressure of the gas vent 7 is set to 50 kPa or higher and 250 kPa or lower. This allows for preventing the possibility that the gas vent 7 is opened during storage of the battery under a high temperature condition, for example, during storage under such a harsh condition as at an ambient temperature of 65 degrees centigrade for 30 days. It can be also ensured that an increase in temperature during overcharge is kept as low as below the boiling point of the electrolyte, thereby preventing the possibility that some electrolyte at above the boiling point is emitted when the vent is opened.

### Second Embodiment

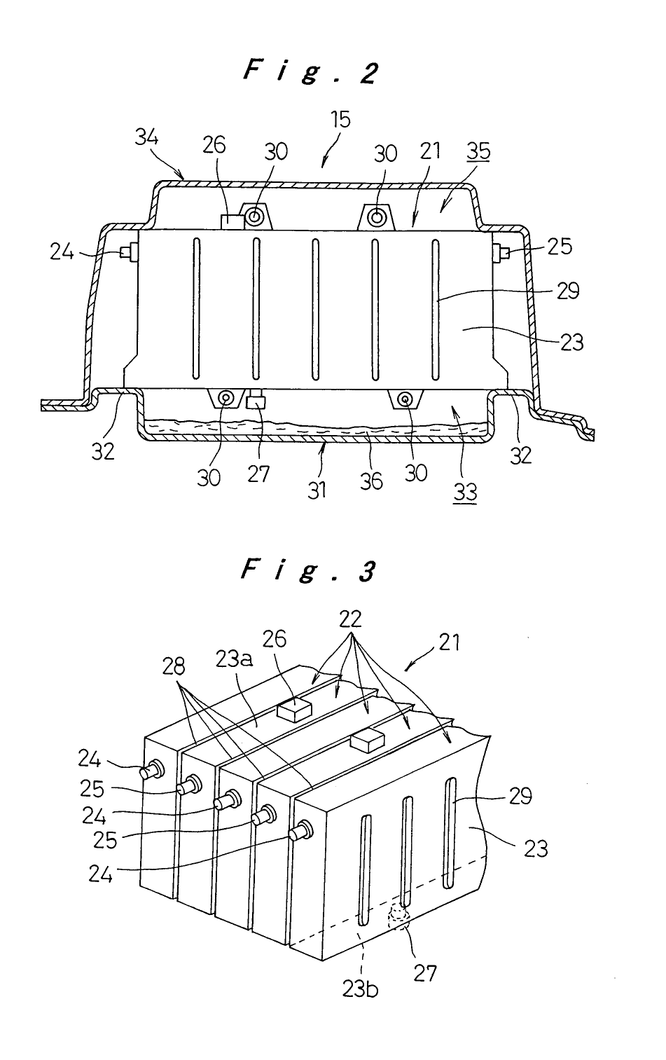

With reference to FIGS. 2 to 4, a description will now be given of a second embodiment in which the present invention is applied to a battery pack incorporated into a hybrid car.

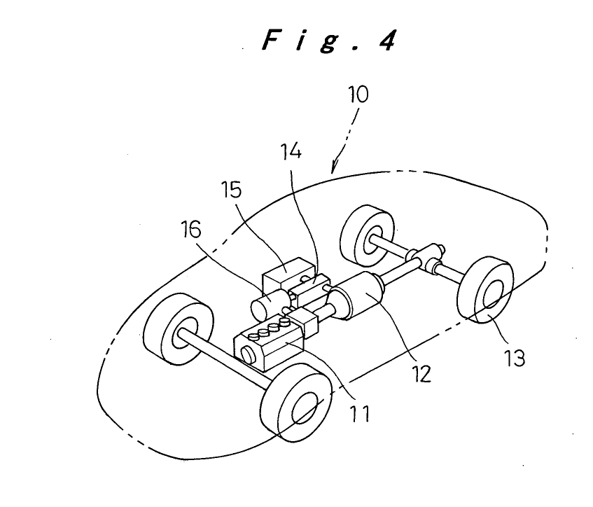

As shown in FIG. 4, a hybrid car 10 as a battery operated device is designed to drive traction wheels 13 using either an engine 11 or a motor 12 or both of them. The motor 12 is driven via an inverter 14 by a power source or a battery pack 15, and the battery pack 15 is charged via the inverter 14 by a generator 16 that is driven by the engine 11.

As shown in FIGS. 2 and 3, the battery pack 15 includes a battery group 21 in which a plurality of prismatic batteries 22 is arranged in parallel to each other. Each battery 22 has a positive electrode terminal 24 and a negative electrode terminal 25 that are disposed at an upper portion on its longitudinal sides, respectively. Each battery 22 is disposed in parallel to another but alternately opposite in the sideward orientation, with the neighboring positive electrode terminal 24 and negative electrode terminal 25 connected to each other. This arrangement allows each battery 22 to be connected in series with another, thereby providing a predetermined output voltage. Each battery 22 has a temperature sensor 26 provided on an upper surface 23a of a battery case 23 to detect the temperature of the battery, and a gas vent 27 on a lower surface 23b.

Furthermore, on each of the mutually opposing sides of the battery case 23, there is provided a vertical path-forming protruded array 29 for forming a cooling path 28 therebetween with the rows of the array protruded therefrom and spaced apart from each other at appropriate intervals. The batteries 22 are retained, with the cooling path 28 formed therebetween, at a plurality of portions above the top and below the bottom thereof using tie rods 30. The batteries 22 are thus formed in one piece to constitute the battery group 21.

The battery group 21 is supported by the lower case 31 with both the bottom edge portions of each battery 22 placed on respective support portions 32 at each side of the lower case 31. Between the support portions 32 of the lower case 31 is protruded downwardly so as to form a coolant flow space 33 for supplying or emitting a coolant to the cooling path 28 between the batteries 22. Furthermore, the sides and the top of the battery group 21 are covered with an upper case 34 to form a coolant flow space 35 for emitting or supplying a coolant onto the upper surface of the battery group 21. The aforementioned lower case 31 and upper case 34 form the exterior of the battery pack 15.

On the bottom portion of the coolant flow space 33, there is placed a liquid absorptive material 36 formed of a material that is coagulated or gelatinized upon absorption of the electrolyte that is emitted from the gas vent 27. The liquid absorptive material 36 is preferably at least one selected from the group consisting of agar, carrageenan, xanthan gum, gellan gum, guar gum, polyvinyl alcohol, polyacrylate-based thickener, water-soluble celluloses, and polyethylene oxide.

According to the battery pack 15 of this embodiment, the gas vent 27 is provided at the lower portion of the battery 22, thereby providing the same operational effects as those described in relation to the first embodiment. Additionally, since the liquid absorptive material 36 is placed below the gas vent 27 of the battery 22, the emitted electrolyte is absorbed by the liquid absorptive material 36. There is thus no possibility that an electrolyte containing a hazardous organic solvent is leaked to the control circuitry of the battery pack 15 placed around the battery group 21 or splattered outside the battery pack 15. It is thus possible to prevent damage to peripheral devices or contamination of the human body or the environment.

The descriptions of the aforementioned embodiments were given only to an example of a prismatic battery. However, the present invention is also applicable to cylindrical batteries or laminated batteries, i.e., a variety of batteries that have a gas vent. Furthermore, description was also made to an example which incorporates a battery group of a plurality of batteries. However, the invention may also be applicable to a battery operated device which incorporates a single battery or a battery pack that includes not only a battery or a battery group but also a safety and control circuit packaged in conjunction therewith.

### EXAMPLE 1

A description will now be given of specific examples which employ a nonaqueous electrolyte rechargeable battery.

(i) Preparation of Positive Electrode

To prepare the positive electrode, LiNi_{1/3}Mn_{1/3}Co_{1/3}O₂ was employed as a positive electrode active material. As the positive electrode material, a positive electrode active material was used which was obtained by mixing raw materials such as lithium carbonate (LiCO₃) and nickel-manganese-cobalt eutectic hydroxide ((NiMnCo)OH₂) in a predetermined number of moles and then baking the resulting substance at 950 degrees centigrade for 10 hours in an atmosphere of air. An N-methyl pyrrolidone solution of polyvinylidene fluoride was prepared to include 100 weight parts of the positive electrode active material, 3 weight parts of acetylene black serving as a conductive material, and 5 weight parts of polyvinylidene fluoride serving as an adhesive material, and then stirred to be mixed to obtain a paste-state positive electrode mixture. Then, an aluminum foil having a thickness of 15 μm was employed as a charge collector, and the paste-state positive electrode mixture was applied to both sides thereof. After having been dried, it was rolled with a reduction roller and then cut into a positive electrode of a predetermined size.

(ii) Preparation of Negative Electrode

The negative electrode was prepared as follows. To begin with, 100 weight parts of massive graphite which had been pulverized and classified into particles about 20 μm in average diameter was mixed with 3 weight parts of styrene/butadiene rubber serving as an adhesive agent, and thereafter, a carboxymethyl cellulose water solution was added to the resulting mixture to yield 1 weight part of solid content. After having been stirred and mixed with each other, it was employed as a paste-state negative electrode mixture. A copper foil having a thickness of 10 μm was employed as a charge collector, and the paste-state negative electrode mixture was applied to both sides thereof. After having been dried, it was rolled with a reduction roller and then cut into a negative electrode of a predetermined size.

(iii) Preparation of Nonaqueous Electrolyte

As the nonaqueous electrolyte, employed was a 11.0 mol/l LiPF₆ dissolved in a solution that was prepared with EC and ethyl methyl carbonate in proportions of 30:70.

(iv) Preparation of Nonaqueous Electrolyte Rechargeable Battery

The aforementioned positive electrode and the aforementioned negative electrode (70 mm in width, 3400 mm in length, 0.07 mm in thickness, and 4.2 A of design capacity) were used to assemble a cylindrical nonaqueous electrolyte rechargeable battery. The steps of the assembly will be described below. The aforementioned stripe-shaped positive and negative electrodes were laminated with a separator of porous polyethylene film interposed therebetween, and then rolled in the longitudinal direction into a scroll-patterned electrode assembly. The resulting assembly was placed in an aluminum battery case. Subsequently, one end of a lead of nickel was crimped to the negative electrode, and the other end was soldered to a sealing plate, thereby implementing an outer terminal of the negative electrode. On the other hand, one end of a positive electrode lead of aluminum was attached to the positive electrode, and the other end was connected to the battery case, thereby implementing the battery case as an outer terminal of the positive electrode. Here, the sealing plate was provided with a gas vent of aluminum/nickel clad material having a thickness of 15 μm. It should be noted that it was already known to work at an actuation pressure of 50 kPa. A nonaqueous electrolyte was poured into the battery case, which was then sealed by laser via an insulating seal gasket coated with petroleum pitch. Finally, an insulating tube predominantly composed of polyethylene terephthalate was thermally contracted and thereby integrated with the exterior case. Thus, the fabrication of a cylindrical nonaqueous electrolyte rechargeable battery was completed.

(v) Preparation of Nonaqueous Electrolyte Rechargeable Battery Pack

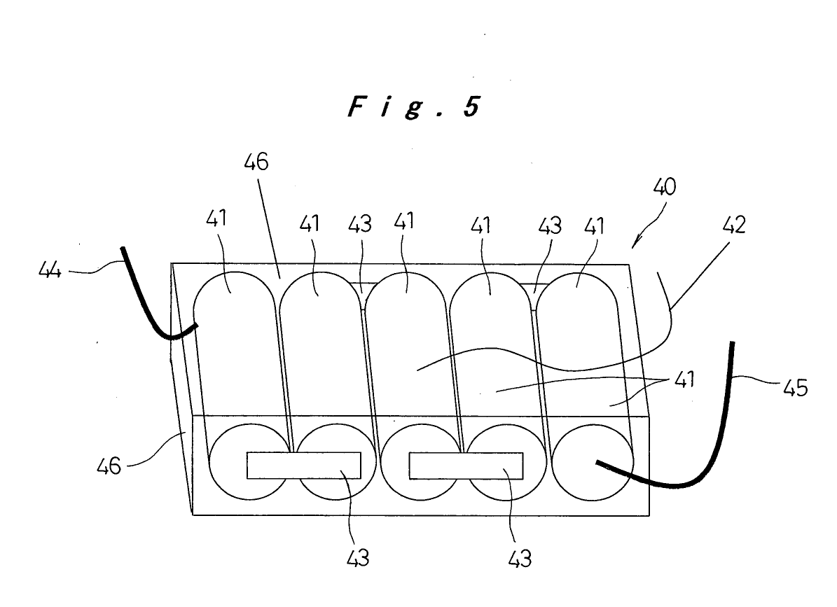

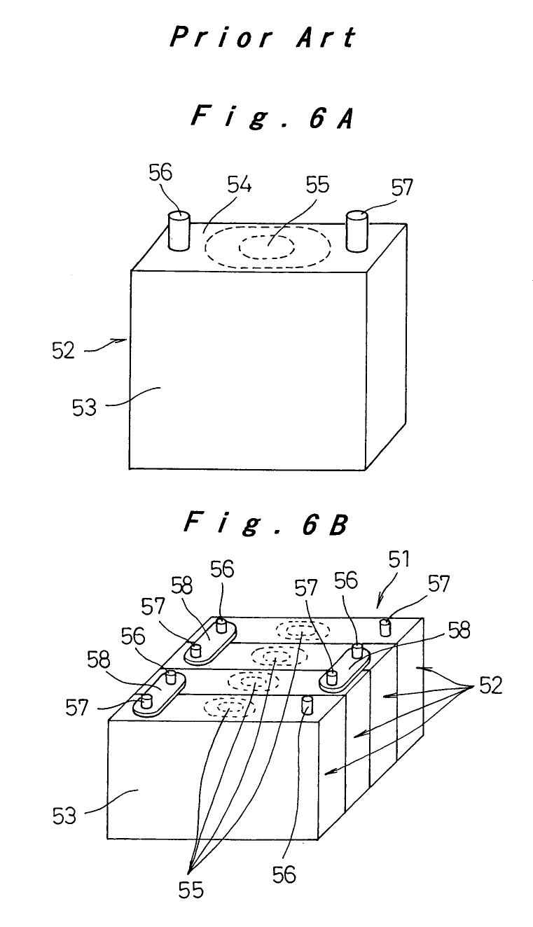

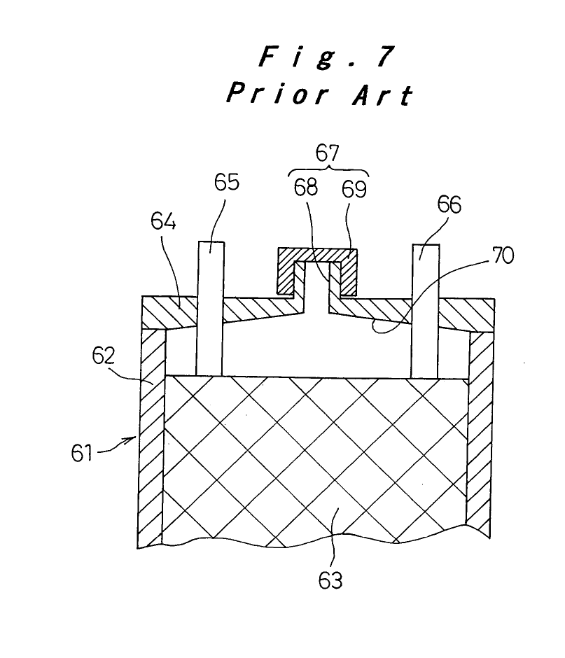

As shown in FIG. 5, five of the aforementioned nonaqueous electrolyte rechargeable batteries 41 were arranged sideward in parallel to each other with separator plates (not shown) of polypropylene 2 mm in thickness employed to ensure insulation between cells. Additionally, batteries 41 were connected in series to each other to form a battery pack. To connect between the batteries 41, connection plates 43 of nickel were used to connect therebetween by resistance welding. Furthermore, a thermocouple 42 was attached to a battery 41 that was placed at the center in order to monitor the temperature of the battery during test. Then, a positive electrode terminal 44 and a negative electrode terminal 45 were connected to the batteries 41 at the ends of the battery pack, respectively. Finally, the battery pack was covered with an exterior case 46 made of ABS resin. A nonaqueous electrolyte rechargeable battery pack 40 was fabricated in this manner. At that time, the gas vent (not shown) of each battery 41 in the pack 40 was located at the lower portion thereof and a gelling agent of polyvinyl alcohol was placed to be in contact with the gas vent (not shown). This pack is employed as the nonaqueous electrolyte rechargeable battery pack according to the example 1.

(vi) Overcharge Test

A continuous overcharge test was carried out on the aforementioned nonaqueous electrolyte rechargeable battery pack under a temperature environment of 40 degrees centigrade at a constant current of 5 A for 30 hours.

(vii) Storage Test

The aforementioned nonaqueous electrolyte rechargeable battery pack was charged with a constant current of 1 A up to 4.2 V, and thereafter further charged at a constant voltage of 4.2 V until the current reading showed 50 mA. Subsequently, the battery pack was stored for 60 days under a temperature environment of 65 degrees centigrade to check and see how the gas vent worked.

### EXAMPLE 2

This example was the same as the example 1 except that the gas vent was fabricated to have both the surfaces of an aluminum foil coated with laminated resin of polypropylene (each having a thickness of 70 μm) and an actuation pressure of 30 kPa.

### EXAMPLE 3

This example was the same as the example 1 except that the gas vent had a clad material having a thickness of 45 μm and an actuation pressure of 150 kPa.

### EXAMPLE 4

This example was the same as the example 1 except that the gas vent had a clad material having a thickness of 75 μm and an actuation pressure of 250 kPa.

### EXAMPLE 5

This example was the same as the example 1 except that the gas vent had a clad material having a thickness of 90 μm and an actuation pressure of 300 kPa.

### EXAMPLE 6

This example was the same as the example 1 except that no liquid absorptive gelling agent was placed in the nonaqueous electrolyte rechargeable battery pack.

### COMPARATIVE EXAMPLE

This example was the same as the examples 1 to 6 except that the gas vent was disposed on top of the nonaqueous electrolyte rechargeable battery in the nonaqueous electrolyte rechargeable battery pack.

TABLE 1

| | | | | | | | Liquid |
|---|---|---|---|---|---|---|---|
| | | | | | | Availability | leakage |
| | Location | Gas vent | | | | of liquid | out of |
| | of gas | actuation | | Overcharge | Storage | absorptive | the |
| | vent | pressure | | test | test | material | pack |
| Example | Bottom | 50 | KPa | 37° C. | Not | Available | Not |
| 1 | | | | | actuated | | found |
| Example | Bottom | 30 | KPa | 35° C. | Actuated | Available | Found |
| 2 | | | | | | | |
| Example | Bottom | 150 | KPa | 42° C. | Not | Available | Not |
| 3 | | | | | actuated | | found |
| Example | Bottom | 250 | KPa | 49° C. | Not | Available | Not |
| 4 | | | | | actuated | | found |
| Example | Bottom | 300 | KPa | Liquid | Not | Available | Not |
| 5 | | | | vapor | actuated | | found |
| | | | | 99° C. | | | |
| Example | Bottom | 50 | KPa | 37° C. | Not | Not | Found |
| 6 | | | | | actuated | available | |
| Compara- | Top | 50 | KPa | Liquid | Not | Available | Not |
| tive | | | | vapor | actuated | | found |
| example | | | | 117° C. | | | |

In relation to each of the aforementioned examples 1 to 6 and comparative example, Table 1 shows the location of the gas vent, the actuation pressure of the gas vent, the result of the overcharge test, whether or not the gas vent was actuated during the storage test, the availability of the liquid absorptive material, and whether or not liquid leakage out of the pack was found. The example 1 and the comparative example showed that when opened, the gas vent located at the lower portion allowed the electrolyte to flow out of the battery to stop the battery function, thereby terminating overcharge to keep only a slight increase in temperature. On the other hand, with the gas vent located on the top, part of the electrolyte was left in the battery in the form of liquid even after the gas vent was opened, thereby causing the overcharge state to continue and the temperature of the battery to continue rising during the charge test. Thus, the electrolyte vaporized at above its boiling point was found.

The examples 1 to 5 provided preferable results that the gas vent which was actuated at pressures 50 kPa to 250 kPa allowed the temperature of the battery in the overcharge test to be at as low as below 50 degrees centigrade, also allowing the gas vent not to be actuated in the storage test. On the other hand, at an actuation pressure of 30 kPa, i.e., below 50 kPa (Example 2), safety can be assured against overcharge. However, since the gas vent was found to be actuated during the high-temperature storage of the battery, it is problematic with reliability when its practical service range is taken into account. Furthermore, at an actuation pressure of 300 kPa, i.e., above 250 kPa (Example 5), overcharge after the gas vent was opened is terminated by the battery function being ceased by the emission of the electrolyte, thereby realizing the mechanism of the present invention. However, the high actuation pressure causes the battery temperature during overcharge to rise to as high as 99 degrees centigrade. Thus, the electrolyte vaporized at above its boiling point was unpreferably found immediately after the gas vent was opened.

The example 1 and the example 6 showed that the placement of the liquid absorptive material prevented the emitted electrolyte from being leaked out of the pack even after the gas vent was actuated. As a result, it turned out that damage to peripheral devices or contamination of the human body or the environment could be avoided.

The battery operated device according to the present invention can make it sure that the electrolyte is emitted out of the battery case when the gas vent is actuated. As a result, the battery function is ceased to thereby provide dramatically improved safety against overcharge or the like. Accordingly, the present invention is useful for a wide variety of devices such as personal computers, portable electronic devices, various types of home electrical products, motor assisted bicycles, motor-driven wheelchairs, motorbikes, automobiles, electric vehicles particularly including hybrid cars, robots, and power source devices for power supply or backup use. The specific embodiments and examples of the present invention described above are intended to make the technical contents of the present invention apparent to those skilled in the art. It is thus to be understood that those embodiments and examples are not intended to limit the technical scope of the invention but may be modified in a variety of ways within the scope of the claims set forth below.

What is claimed is:

1. A battery operated device equipped with one or more batteries each including a positive electrode, a negative electrode, a separator, and an electrolyte in a battery case, wherein the battery has a gas vent that is opened due to an increase in pressure inside the battery case, and is configured to dispose the gas vent at a lower position thereof when installed in the battery operated device.

2. The battery operated device according to claim 1, wherein the gas vent is actuated at a pressure of 50 kPa or higher and 250 kPa or lower.

3. The battery operated device according to claim 1, incorporating a battery pack which has a plurality of the batteries loaded and packaged therein.

4. The battery operated device according to claim 1, wherein a liquid absorptive material is disposed at least under the gas vent of the battery.

5. The battery operated device according to claim 4, wherein the liquid absorptive material is formed of a material which is coagulated or gelatinized when it absorbs the electrolyte.

6. The battery operated device according to claim 5, wherein the material that absorbs the electrolyte to thereby gelatinize includes at least one selected from the group consisting of agar, carrageenan, xanthan gum, gellan gum, guar gum, polyvinyl alcohol, polyacrylate-based thickener, water-soluble celluloses, and polyethylene oxide.
